(19) United States
(12) Patent Application Publication
(10) Pub. No.: US 2016/0066504 A1
(43) Pub. Date: Mar. 10, 2016

(54) Crop Stubble Flattening and Slicing Apparatus

(71) Applicant: Michael Holman, Angola, IN (US)

(72) Inventor: Michael Holman, Angola, IN (US)

(21) Appl. No.: 14/478,246

(22) Filed: Sep. 5, 2014

(51) Int. Cl. A01D 34/835; A01D 45/02; A01D 75/18

(52) U.S. Cl. CPC A01D 34/8355; A01D 75/18; A01D 45/02

(57) ABSTRACT

A stalk stubble flattening an slicing apparatus for use on agricultural implements for harvesting row crops to bend over stub stalks to prevent undue wear and damage to tires of the implement. A plurality of slicing disc blades are mounted on a shaft that is rotatably mounted by bearings to a top surface of a curved flattening plate. The shaft is perpendicular to, and the disc blades are parallel to, the direction of travel. A plurality of corresponding slots are provided through the flattening plate such that the perimeter edges of the discs extend therethrough below the bottom surface of the flattening plate. The blades travel over the stalks and slice them longitudinally.

### BACKGROUND OF THE INVENTION

1. Field of the Invention

The present invention relates to field crop harvesting machines and, more particularly, to an apparatus for mounting to such harvesting machines for flattening cut crop stubble to mitigate the risk of damaging the tires of the harvesting machine by overrunning the upright stalk stubs.

2. Description of the Related Art

The related art includes crop stubble flattening apparatus which are used on motor driven farm implements or vehicles such as, for example, tractors, harvesters and corn pickers. The flattening apparatus typically is affixed to the implement rearward of a corn picking head, for example, but ahead of the vehicle's tires. After the corn stalk, for example, is cut by the picking head a short stub or stubble stalk remains projecting several inches upward from the ground. Such short stubble can be relatively stiff and perhaps sharp. The rubber tires of the implement can be damaged or punctured by running over the stubble. To ameliorate that risk, it is known to pivotally mount a curved plate ahead of each tire that is pressed downward toward the ground under spring bias. The plate serves to bend over and flatten newly cut but standing crop stubble so that the tire following behind is less likely to be punctured or damaged if it runs over the crop stubble. Exemplary prior art flattening apparatus are shown and described in U.S. Pat. No. 4,149,361; U.S. Pat. No. 8,418,432; and, U.S. Pat. No. 8,567,167.

Crop stubble or stalks are sometimes so resistant to bending, folding or breaking under the pressure of the spring loaded plate that the stubble is known sometimes to spring back upright after the plate passes over it, thereby continuing to present a hazard to a following tire that may run over it.

It would be desirable to provide a crop stubble flattening apparatus that more effectively renders the crop stubble harmless to rubber tires of the harvesting implement or vehicle. It would also be desirable to enhance and accelerate the natural decomposition of the stalks into beneficial compost. This and other desirable advantages are obtained by the present invention.

### SUMMARY OF THE INVENTION

In accordance with one aspect of the present invention, a crop stubble flattening apparatus is provided, including a flattening plate adapted to be pivotally secured to an agricultural implement and slide over row crop stalks. A plurality of discs is rotatably supported on the plate and extends below a bottom surface thereof so that the row crop stalks can be flattened and sliced longitudinally by the discs. The longitudinal flattening and slicing renders the crop stubble harmless to rubber tires of the harvesting implement or vehicle and also enhances and accelerates the natural decay of the stalks.

In one form thereof, the present invention thereof is directed to crop stubble flattening apparatus, including a flattening plate adapted to be pivotally secured and slide over row crop stalks, and a plurality of discs rotatably supported on the plate and extending below a bottom surface thereof, whereby the row crop stalks can be sliced by the discs.

The plurality of discs can rotate as a unit, or at least one of the plurality of discs can rotate independently of at least one of the other discs. Preferably, the flattening plate and/or the plurality of discs are spring biased downwardly toward the row crop stalks. Also preferably, the plurality of discs are carried on a shaft supported on the flattening plate, and the shaft is perpendicular to, and the disc blades are parallel to, a direction of travel.

In another form thereof, the present invention is directed to a crop stubble flattening apparatus including a flattening plate adapted to be pivotally secured to an agricultural implement and slide over row crop stalks. A spring is adapted to bias the flattening plate downwardly toward the row crop stalks, and one or more slots extend through the flat plate. A plurality of discs are rotatably supported on the plate and extend through the one or more slots to below a bottom surface of the flat plate, whereby the row crop stalks can be sliced by the discs.

The plurality of discs rotate as a unit or at least one of the plurality of discs can rotate independently of at least one of the other discs. Preferably, the plurality of discs are carried on a shaft rotatably supported on the flattening plate, and the shaft is perpendicular to, and the disc blades are parallel to, a direction of travel. The flattening plate preferably includes a curved section that curves convexly downwardly toward the ground during use, and the one or more slots are located and extend through the curved section. A stiffening bracket can be secured to and extend between ends of the flattening plate curved section.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is perspective, partially exploded view of a prior art crop stubble flattening apparatus.

FIG. 2 is a perspective, partially exploded view of an exemplary embodiment of an improved crop stubble flattening apparatus in accordance with the present invention.

FIG. 3 is a perspective, assembly view of the apparatus of FIG. 2, shown attached to a typical structural cross-member of a corn picker implement.

FIG. 4 is a left side view of the apparatus of FIG. 3.

FIG. 5 is a right side view of the apparatus of FIG. 3, shown flattening and slicing crop stubble.

FIG. 6 is a top view of the apparatus of FIG. 3.

FIG. 7 is a bottom view of the apparatus of FIG. 3.

FIG. 8 is a front view of the apparatus of FIG. 3.

FIG. 9 is a rear view of the apparatus of FIG. 3.

FIG. 10 is a partial perspective view, partially in section, of the apparatus of FIG. 2, taken in section plane 10-10 of FIG. 4 and viewed in the direction of the arrows.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

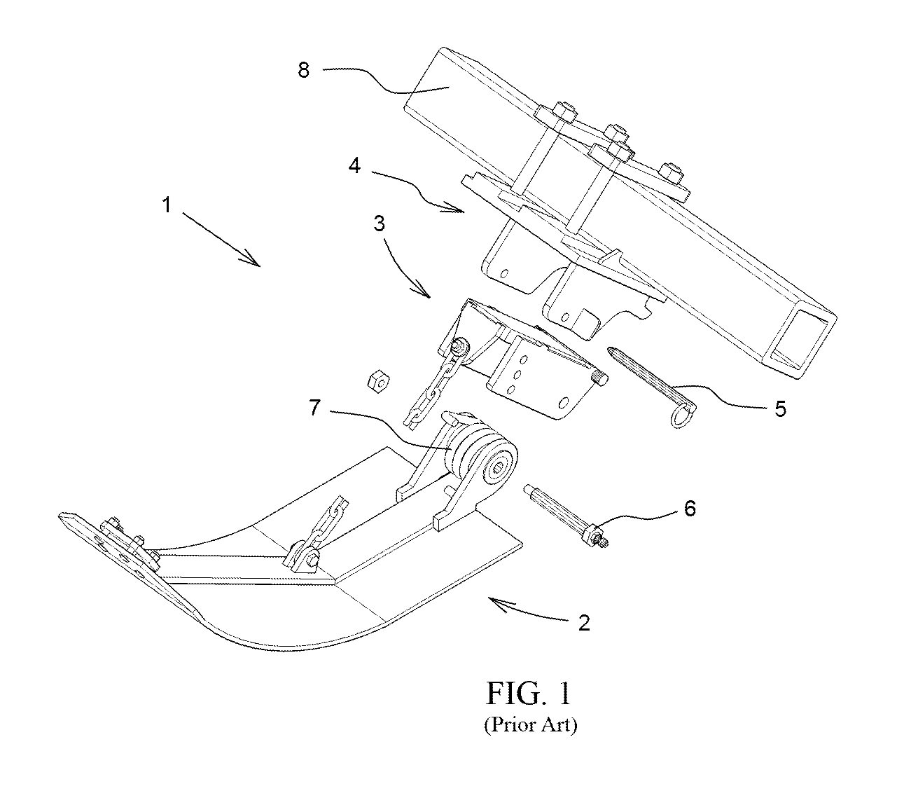

Referring to FIG. 1, there is illustrated an example of a crop stubble flattening apparatus 1 known in the prior art. Apparatus 1 includes as major components a shoe 2, a pivot mount 3, and an adapter 4 for mating with and attaching to a portion of a corn picking or other agricultural implement. In operation, the pivot mount 3 is held fixed to adapter 4 by pin 5 in one of a plurality of orientations. Shoe 2 is pivotally mounted to pivot mount 3 by pivot bolt 6 and is biased to pivot downward toward the ground under spring bias provided by torsion spring 7 that acts against and between pivot mount 3 and shoe 2. The spring 7 allows the shoe 2 to follow the contour of the ground as the implement moves through the field picking corn. Apparatus 1 is mounted to a structural member 8 of the implement behind the corn picker head and ahead of any tire that may follow in the path of the picker head. Shoe 2 presses down on and attempts to flatten the standing crop stubble before the tire runs over the stubble.

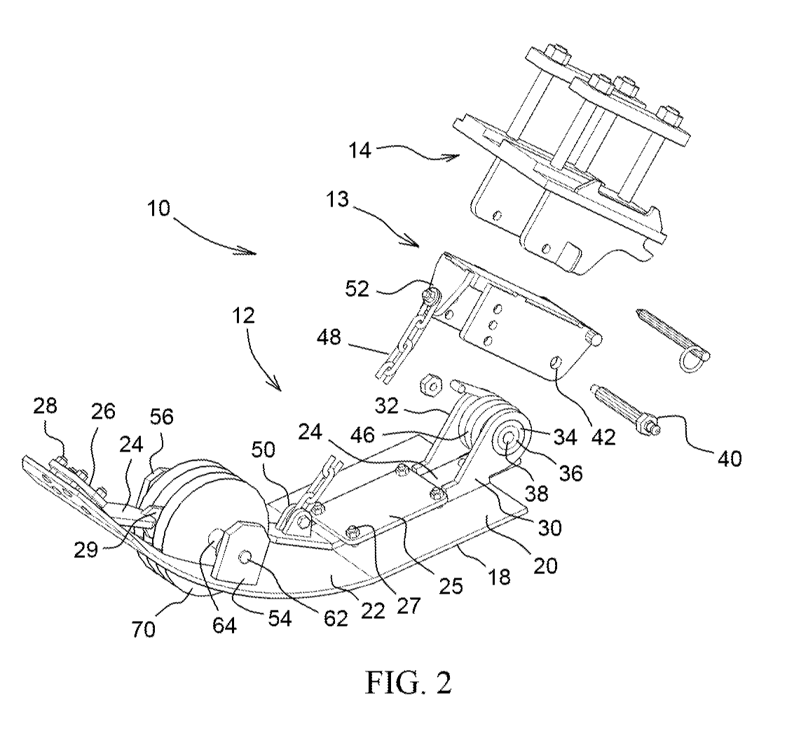

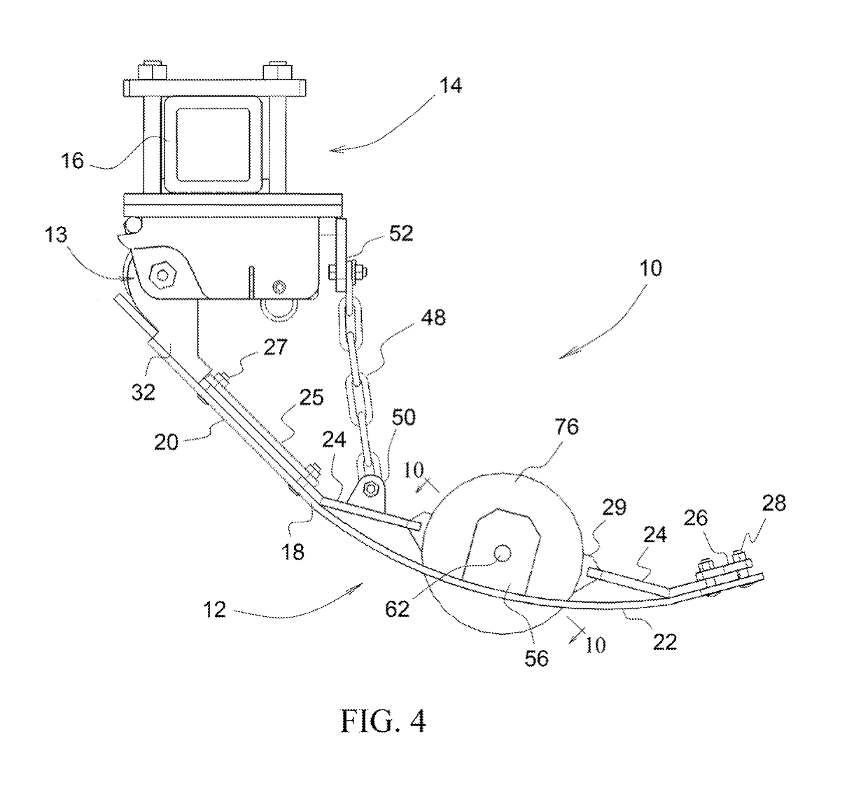

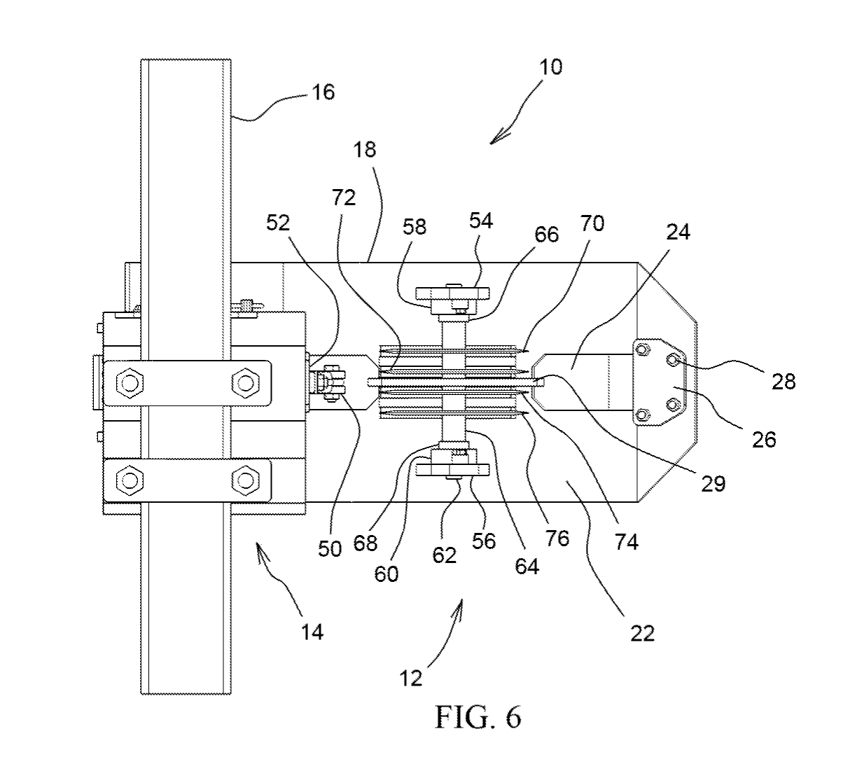

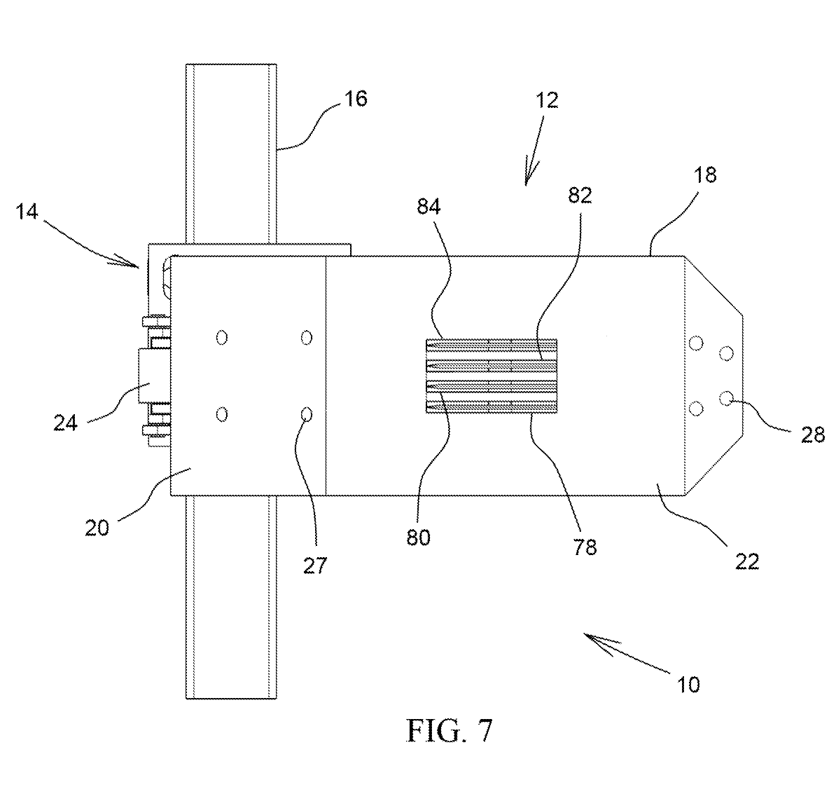

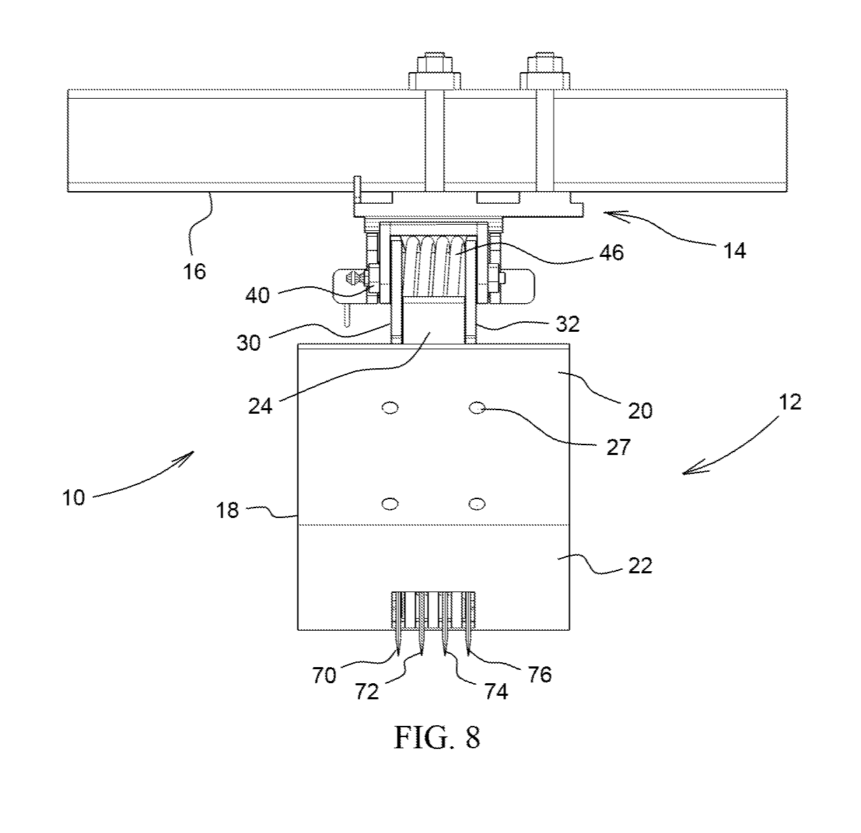

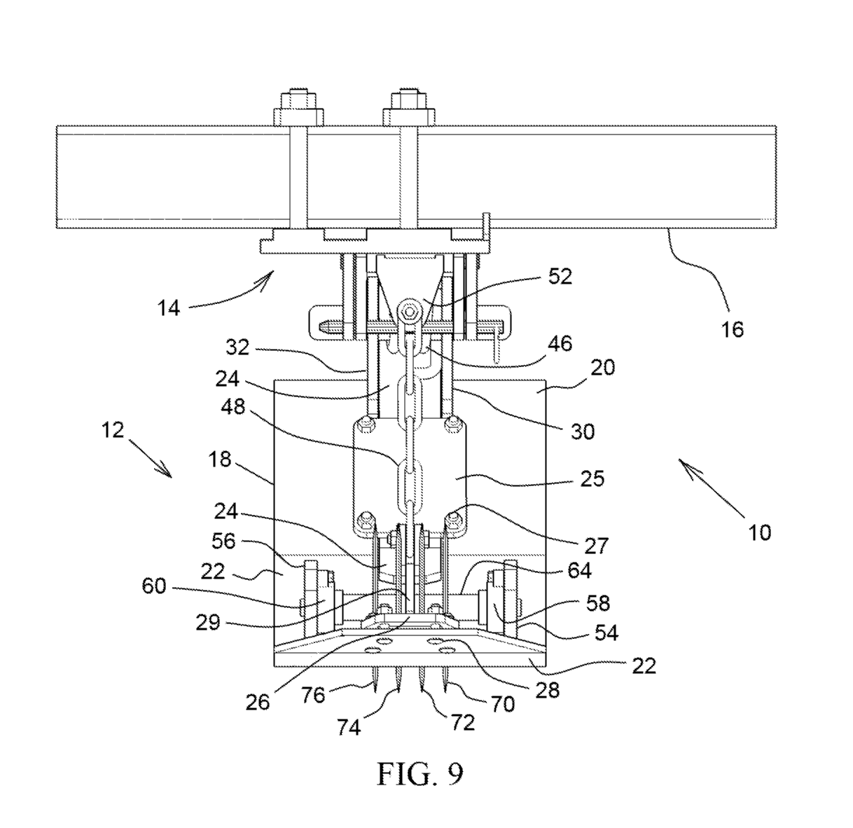

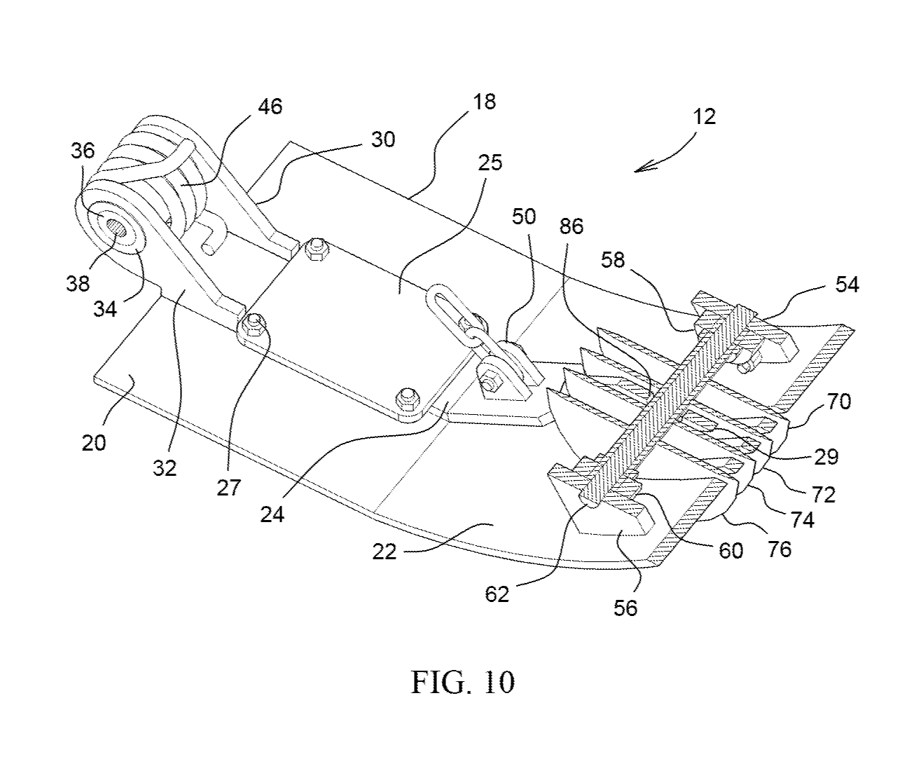

In FIGS. 2-10, an exemplary embodiment of the present invention is illustrated as crop stubble flattening and slicing apparatus 10, including a shoe 12, a pivot mount 13, and an adaptor 14 for mating with and attaching to a portion of a corn picking or other agricultural implements.

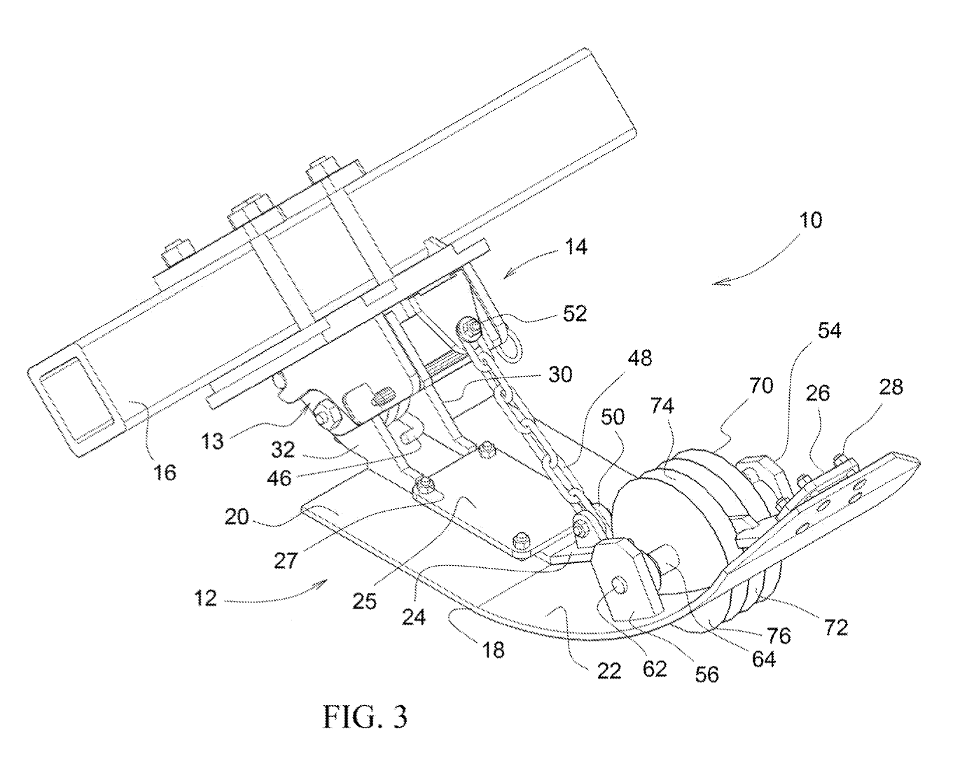

In FIGS. 3-9, apparatus 10 is shown assembled and connected to a representative structural cross-member 16 of a corn picking implement or vehicle. Adaptor 14 can be constructed in different configurations to mate with and mount to an appropriate structural member of different models of corn picking and other machines as offered by various manufacturers of such implements.

Shoe 12 includes a shoe plate 18 having a leading planar section 20 and a following curved section 22 that curves convexly downwardly toward the ground during use. A stiffening bracket 24 can be clamped atop section 20 of shoe plate 18 near the front end thereof by clamping plate 25 which is bolted to shoe 12 by bolts 27. Stiffening bracket 24 can be clamped to plate 18 near the rear end thereof by clamping plate 26 which is bolted to shoe 12 by bolts 28. Alternatively, stiffening bracket 24 can be welded to shoe plate 18 thereat instead of using clamping plates and bolts. Stiffening bracket 24 includes an intermediate portion 29 that is oriented orthogonally relative to the end portions thereof such that the narrowest dimension of portion 29 is oriented transversely to shoe plate 18, for reasons that will be made apparent below.

Welded or otherwise fixed to stiffening bracket 24 is a pair of spaced side plates 30, 32 that extend upwardly from the upper surface of section 20 of shoe plate 18. Extending transversely between and through aligned holes in side plates 30, 32 are an outer cylindrical bushing 34 and a concentric inner cylindrical bushing 36. A central transverse bore 38 extends through inner bushing 36 and is sized to receive a pivot pin 40 therein in free pivoting relationship. Pivot pin 40 is also received through each of a pair of holes 42, 44 in pivot mount 13 when shoe 12 is assembled thereto, thereby allowing shoe 12 to pivot relative to pivot mount 13 about pivot pin 40 against spring bias provided by torsion spring 46.

One free end of torsion spring 46 bears against stiffening bracket 24 and the other free end of torsion spring 46 bears against pivot mount 13. Torsion spring 46 is arranged to bias shoe 12 and pivot mount 13 apart. A chain 48 extends between chain anchor 50 welded to spring bar 24 and chain anchor 52 welded to pivot mount 13. Chain 48 is selected in length to limit the maximum excursion of shoe 12 away from pivot mount 13 under bias provided by torsion spring 46.

Also welded or otherwise affixed to shoe plate 18 is a pair of spaced axle supports 54, 56, each of which extends upwardly from the upper surface of curved section 22 of shoe plate 18. Mounted to the inboard sides of supports 54, 56 is a pair of axle bearings 58, 60 that support an axle 62 extending therethrough and therebetween. Axle 62 carries coaxially and rotationally thereabout a cylindrical tube 64 which is fixed to axle 62 by a pair of locking collars 66, 68 having set screws that engage axle 62. Collars 66, 68 maintain tube 64 against lateral motion between bearings 58 and 60.

Welded or otherwise affixed to tube 64 are four spaced discs 70, 72, 74, 76, mounted orthogonally and concentrically thereto. The diameter of discs 70-76, and the location of axle 62 above curved section 22 of shoe plate 18, are such that the lower perimeter edges of discs 70-76 extend through longitudinal slot openings 78, 80, 82, 84, through shoe plate 18. Discs 70-76, tube 64, and axle 62 preferably rotate as a unit relative to bearings 58, 60 and relative to shoe 12. Alternatively, discs 70-76 can be provided with inner central bore openings adapted to receive the axle 62 and the tube 64 can be cut and located between the discs as spacers, thereby allowing each of the discs 70-76 to also rotate independent of one another.

Intermediate portion 29 of stiffening bracket 24 extends between adjacent inner discs 72, 74 and has an aperture 86 sized to permit tube 64 to extend therethrough without interference and with sufficient clearance to allow tube 64 to rotate relative thereto. Stiffening bracket 24 thus spans a chord of the plate curved section 22 thereby supporting and maintaining the curved shape thereof.

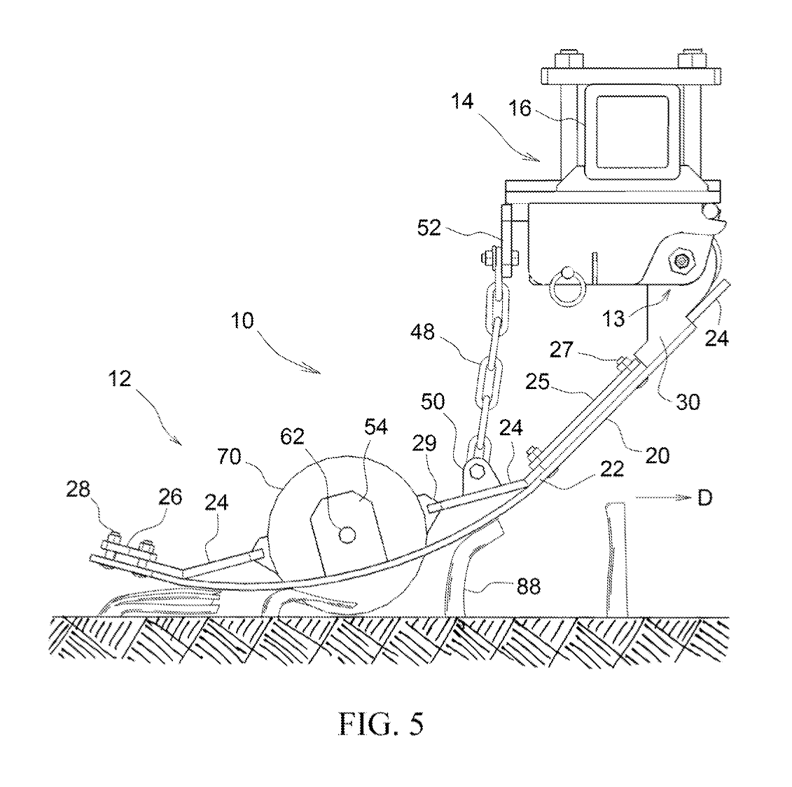

The portion of discs 70-76 that extend through slots 78-84 are oriented with their sharp edges running in the direction of travel D of shoe 12 and apparatus 10 when in use on a corn picker or other implement (See FIG. 5). That is, the discs 70-76 are each oriented in planes which are vertical and parallel with the direction of travel D. Consequently, discs 70-76 are pressed against crop stubble 88 (FIG. 5) as the stubble is flattened by shoe 12, with the result that discs 70-76 tend to slice the stub stalks of the crop stubble 88 longitudinally, thereby substantially weakening the stubble and making it more likely to remain flattened until the tire runs over it, or at least making it less stiff and less capable of damaging or puncturing the tire. The sliced stalks will also decompose in the field more rapidly.

While this invention has been described as having an exemplary design, the present invention may be further modified within the spirit and scope of this disclosure. This application is therefore intended to cover any variations, uses, or adaptations of the invention using its general principles.

What is claimed is:

1. Crop stubble flattening apparatus, comprising:
a flattening plate adapted to be pivotally secured and slide over row crop stalks; and
a plurality of discs rotatably supported on the plate and extending below a bottom surface thereof;
whereby the row crop stalks can be sliced by the discs.

2. The crop stubble flattening apparatus of claim 1, wherein:
the plurality of discs rotate as a unit.

3. The crop stubble flattening apparatus of claim 1, wherein:
at least one of the plurality of discs can rotate independently of at least one of the other discs.

4. The crop stubble flattening apparatus of claim 1, wherein:
said flattening plate is spring biased downwardly toward the row crop stalks.

5. The crop stubble flattening apparatus of claim 1, wherein:
said plurality of discs are spring biased downwardly toward the row crop stalks.

6. The crop stubble flattening apparatus of claim 1, wherein:
the plurality of discs are carried on a shaft supported on the flattening plate; and,
the shaft is perpendicular to, and the disc blades are parallel to, a direction of travel.

7. The crop stubble flattening apparatus of claim 2, wherein:
said plurality of discs are spring biased downwardly toward the row crop stalks.

8. The crop stubble flattening apparatus of claim 3, wherein:
said plurality of discs are spring biased downwardly toward the row crop stalks.

9. The crop stubble flattening apparatus of claim 6, wherein:
the plurality of discs rotate as a unit.

10. The crop stubble flattening apparatus of claim 6, wherein:
at least one of the plurality of discs can rotate independently of at least one of the other discs.

11. Crop stubble flattening apparatus, comprising:
a flattening plate adapted to be pivotally secured to an agricultural implement and slide over row crop stalks;
a spring adapted to bias the flattening plate downwardly toward the row crop stalks;
one or more slots extending through the flat plate;
a plurality of discs rotatably supported on the plate and extending through the one or more slots to below a bottom surface of the flat plate;
whereby the row crop stalks can be sliced by the discs.

12. The crop stubble flattening apparatus of claim 11, wherein:
the plurality of discs rotate as a unit.

13. The crop stubble flattening apparatus of claim 11, wherein:
at least one of the plurality of discs can rotate independently of at least one of the other discs.

14. The crop stubble flattening apparatus of claim 11, wherein;
the plurality of discs are carried on a shaft rotatably supported on the flattening plate; and,
the shaft is perpendicular to, and the disc blades are parallel to, a direction of travel.

15. The crop stubble flattening apparatus of claim 11, wherein;
the flattening plate includes a curved section that curves convexly downwardly toward the ground during use; and,
wherein the one or more slots are located and extend through the curved section.

16. The crop stubble flattening apparatus of claim 15, wherein:
the plurality of discs rotate as a unit.

17. The crop stubble flattening apparatus of claim 15, wherein:
at least one of the plurality of discs can rotate independently of at least one of the other discs.

18. The crop stubble flattening apparatus of claim 15, wherein:
the plurality of discs are carried on a shaft rotatably supported on the flattening plate curved section.

19. The crop stubble flattening apparatus of claim 19, wherein:
a stiffening bracket is secured to and extends between ends of the flattening plate curved section.

20. The crop stubble flattening apparatus of claim 19, wherein:
the shaft is rotatably mounted by bearings to a top surface of the flattening plate curved section.
